(19) United States
(12) Patent Application Publication
(10) Pub. No.: US 2004/0173374 A1
(43) Pub. Date: Sep. 9, 2004

(54) Anti-abrasive flat flexible cable

(76) Inventors: Hsi-Yu Chen, Taipei (TW); Yi-Yung Tsai, Changhua (TW); Chien-Kuo Kuan, Taipei (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/791,100

(22) Filed: Mar. 2, 2004

(30) Foreign Application Priority Data
Mar. 5, 2003 (TW) 092104720
Mar. 5, 2003 (TW) 092104721

(51) Int. Cl. H01B 7/08

(52) U.S. Cl. 174/117 FF

(57) ABSTRACT

An anti-abrasive flat flexible cable applied to a flatbed scanner is provided to avoid abrasion occurring between the flat flexible cable and a platform of the flatbed scanner. The anti-abrasive flat flexible connected between a circuit board and a carriage of the flatbed scanner bends differentially with the forward or backward movement of the carriage under the platform. It includes a flexible main body connected to the circuit board and the carriage respectively for transmitting electric signals between the circuit board and the carriage; and a weighting object arranged on a portion of the flexible main body, which is possibly to be bent during the movement of the carriage, for pulling the main flexible body away from the platform so as to avoid abrasion.

### FIELD OF THE INVENTION

The present invention relates to an anti-abrasive flat flexible cable (FFC), and more particularly to an anti-abrasive flat flexible cable applied to a flatbed scanner.

### BACKGROUND OF THE INVENTION

Flat flexible cable, a common connecting wire used in electrical devices, provides suitable connecting means in a narrow space. For example, in a flatbed scanner, a moving-around carriage including therein a CCD/CIS is connected with a circuit board by a flat flexible cable. Please refer to FIGS. 1A and 1B which are a top and a cross sectional side views, respectively. The flatbed scanner includes an upper cover (not shown) and a lower housing 10. The lower housing 10 includes therein a carriage 11, a motor and gear set 121, a rail 122, a circuit board 13 and a flat flexible cable 14. The carriage 11 is transmitted by the motor and gear set 121 to move along the rail 122 under the transparent platform 15. Meanwhile, the document or picture placed on the transparent platform 15 is scanned out. The carriage 11 keeps connecting with the circuit board 13 through the flat flexible cable 14 for transmitting signals while moving under the platform 15.

Please refer to FIG. 2A which is a cross-sectional view showing the conventional flat flexible cable structure. The flat flexible cable 14 includes a flexible copper foil 141 coated with a flexible plastic insulating wrapper 142 and mounted thereon two reinforcing plates 143 at two ends thereof, respectively. The reinforcing plates 143 can facilitate the insertion of the flexible copper foil 141 exposed from the plastic insulating wrapper 142 into the slots (not shown) of the carriage 11 and the circuit board 13. The flat flexible cable 14 stretches or bends with the forward or backward movement of the carriage 11. When the flat flexible cable 14 is bent with big curvature, as shown in FIG. 2B, there is great possibility that the bent portion of the flat flexible cable 14 may scratch the transparent platform 15 frequently. Furthermore, since the compact size is required for the modern products, abrasion is likely to occur on the plastic insulating wrapper 142 so as to contaminate the transparent platform 15. The scanning quality may thus be adversely affected.

### SUMMARY OF THE INVENTION

An object of the present invention is to provide an anti-abrasive flat flexible cable applied to a flatbed scanner to avoid abrasion occurring between the anti-abrasive flat flexible cable and the platform of the flatbed scanner during the forward or backward movement of the carriage.

According to a first aspect of the present invention, the anti-abrasive flat flexible cable includes: a flexible main body connected to a circuit board and the carriage respectively for transmitting electric signals between these two devices; and a weighting object arranged on a portion of the flexible main body, which is possible to be bent during the forward movement of the carriage, for pulling the flexible main body away from the platform so as to avoid abrasion.

In one preferred embodiment, the flexible main body includes a flexible conductor having one end connected to the circuit board and the other end connected to the carriage, respectively, for transmitting the electric signals; and a flexible insulating wrapper enclosing the flexible conductor to protect the flexible conductor. Preferably, the flexible conductor is a copper foil and the flexible insulating wrapper is made of thermoplastic material.

In one embodiment, the weighting object includes a plurality of metal bars arranged in parallel and extending in a direction perpendicular to the movement direction of the carriage.

In another embodiment, the weighting object includes a plurality of granular balls distributed on the bent portion of the flexible main body.

Preferably, the weighting object is arranged on an inner surface of the bent portion of the flexible main body during the movement of the carriage.

Preferably, the weighting object is distributed on the flexible main body between the carriage and a halfway portion of the flexible main body.

According to a second aspect of the present invention, the anti-abrasive flat flexible cable includes: a flexible conductor connected to a circuit board and the carriage respectively for transmitting electric signals between these two devices; and a flexible insulating wrapper enclosing and protecting the flexible conductor. The feature of the present invention is that the anti-abrasive flat flexible cable has a curved or wrinkled cross-section to resist against the free bending of the anti-abrasive flat flexible cable.

Preferably, the cross-section of the anti-abrasive flat flexible cable is arc-shaped, V-shaped, or W-shaped.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A is a schematic diagram showing the top view of a conventional flatbed scanner of FIG. 1A;

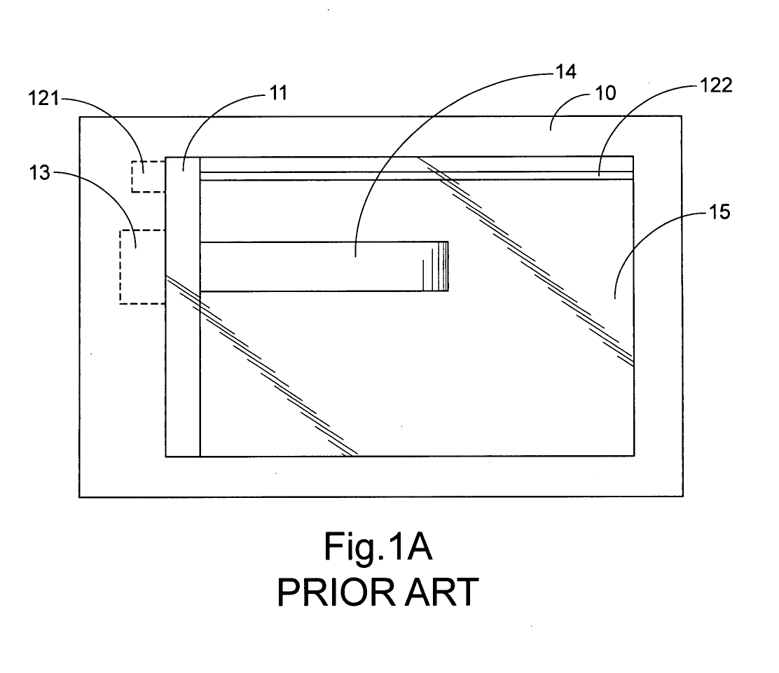

FIG. 1B is a schematic diagram showing a cross sectional side view of the conventional flatbed scanner of FIG. 1A;

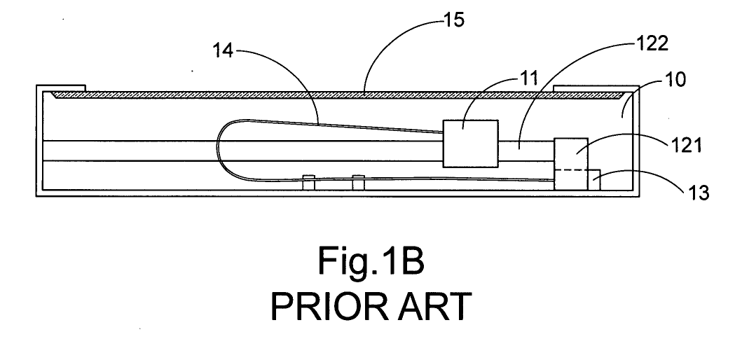

FIG. 2A is a schematic diagram showing a conventional flat flexible cable applied to the flatbed scanner of FIGS. 1A and 1B;

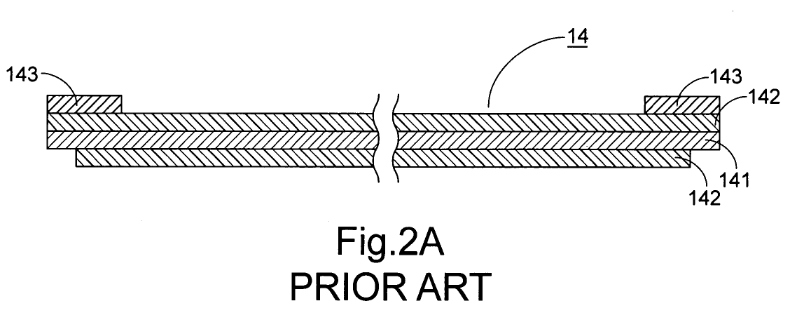

FIG. 2B is a schematic diagram showing the abrasion occurring between the conventional flat flexible cable and a scanning platform when in use;

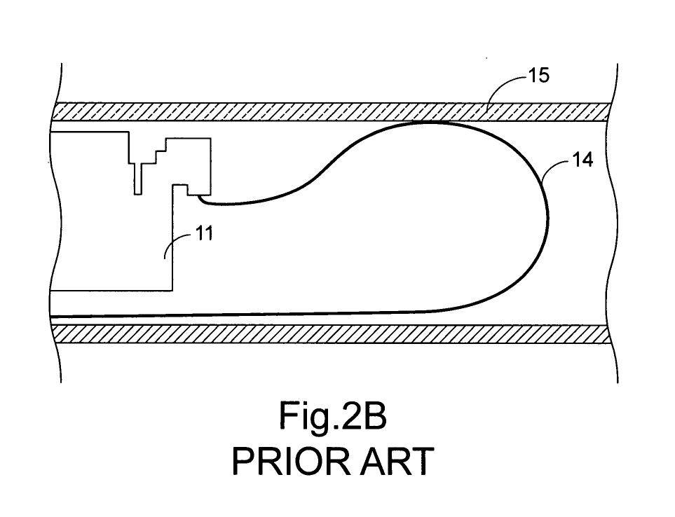

FIG. 3A is a schematic diagram showing a cross sectional side view of a flat flexible cable according to an embodiment of the present invention;

FIG. 3B is a schematic diagram showing a top view of the flat flexible cable in FIG. 3A;

FIG. 3C is a schematic diagram showing a top view of a flat flexible cable according to another embodiment of the present invention;

FIG. 4 is a schematic diagram showing the lowered position of the flat flexible cable relative to the scanning platform to avoid abrasion;

FIG. 5 is a schematic diagram showing a cross sectional side view of a flat flexible cable according to another preferred embodiment of the present invention;

FIGS. 6A, 6B, and 6C are schematic diagrams showing cross sectional side views of three examples of flat flexible cables as shown in FIG. 5 taken along line X-Y; and

FIG. 7 is a schematic diagram showing the lowered respective position of the flat flexible cable relative to the scanning platform to avoid abrasion.

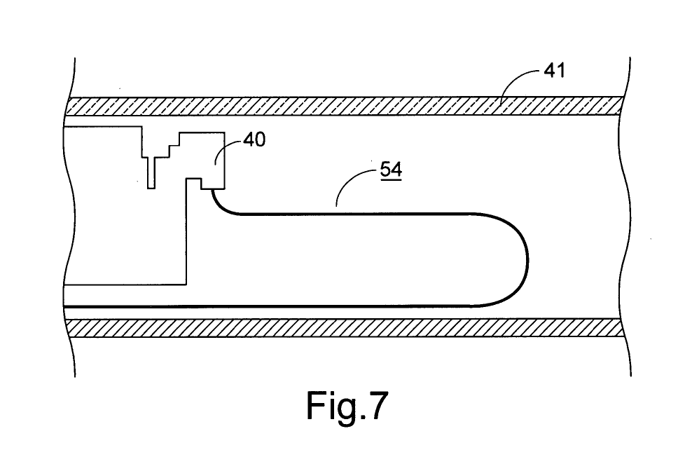

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

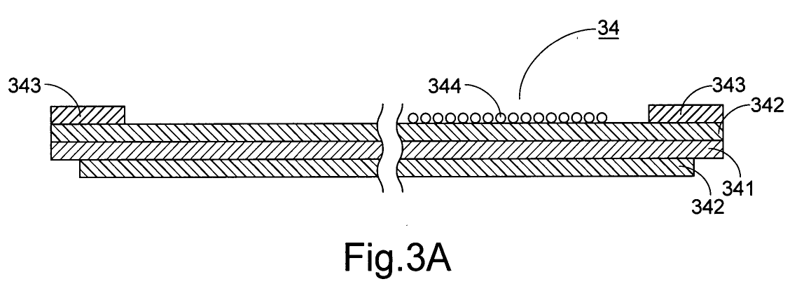

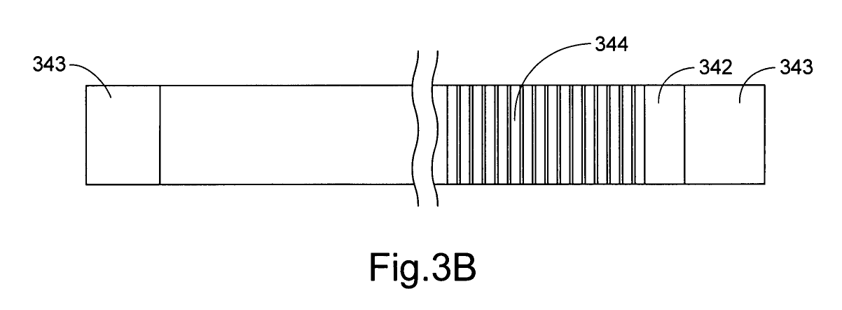

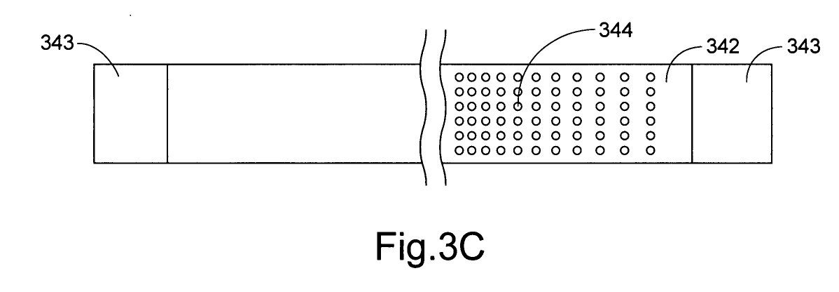

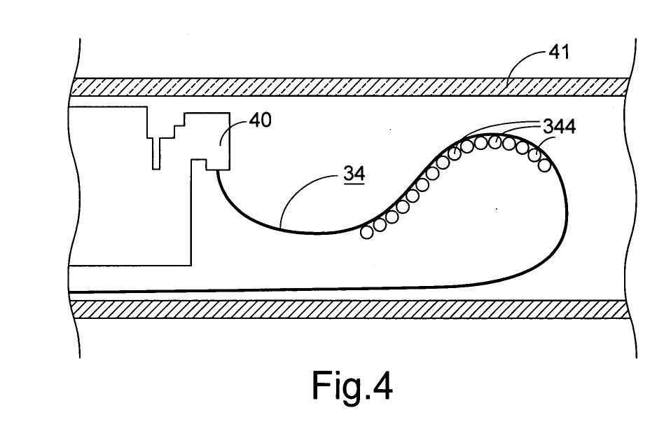

Please refer to FIGS. 3A and 3B illustrating the anti-abrasive flat flexible cable according to the invention. The anti-abrasive flat flexible cable 34 includes a flexible copper foil 341, a flexible insulating wrapper 342 made of thermoplastic material, two rigid reinforcing insulating plates 343 and a weighting object 344. The flexible plastic insulating wrapper 342 encloses the flexible copper foil 341 with two ends of the copper foil 341 exposed to be electrically connected to the circuit board (not shown) and the carriage 40, respectively. The rigid reinforcing insulating plates 343 are used to assist the user to easily plug the exposed copper foil 341 of the flat flexible cable 34 into the slots of the circuit board and the carriage 40. The weighting object 344 in the embodiment includes a plurality of parallel metal bars arranged on the bent portion of the flat flexible cable 34 which is possibly to be in contact with the transparent platform 41, as shown in FIG. 4. The metal bars are preferably arranged to be perpendicular to the movement direction of the carriage 40 so as to turn down with the flat flexible cable one be one smoothly. The clearance between the bent portion of the flat flexible cable 34 and the transparent platform 41 is hence increased to avoid abrasion. The transparent platform 41 can be made of glass or any other suitable transparent material resistant to abrasion.

Alternatively, the weighting object suiting the anti-abrasive flat flexible cable is referred to FIG. 3C, in which the weighting object 344 includes a plurality of granular balls distributed uniformly or non-uniformly on the anti-abrasive flat flexible cable 34. The use of the granular balls as the weighting object minimizes the possible interference of the weighting object with the bending-down action of the flat flexible cable. The weighting object can be arranged on either of the surfaces of the flexible main body. Nevertheless, it is preferred to arrange the weighting object on the inner surface distant from the scanning platform so as to avoid contact with the scanning platform. The material of the weighting object is not restricted to metal. Plastic material is also acceptable so that the weighting object 344 can be formed integrally with the plastic insulating wrapper 342. Generally, it is appropriate to attach about 100 grams of weighting object onto the flexible main body having a weight of 3 grams. The weight of the weighting object 344, however, varies with the distribution thereof on the flexible main body and the size of the flexible main body. In principle, the weight ratio of weighting object 344 to flexible main body is greater than 10. As for the distribution of the weighting object 344 on the flexible main body, it is determined according to the bending degree of the anti-abrasive flat flexible cable. As in the embodiments of the embodiments of the present invention, both the carriage 40 and the circuit board are initially arranged at the same side of the scanner. Since it is impossible for the lower portion of the flexible flat cable 34 to contact with the platform 41 under this circumstance, the weighting object 344 can only be distributed on the flexible insulating wrapper 342 between the carriage 40 and a halfway portion of the flexible flat cable 34. However, the distribution of the weighting object 344 will vary with the relative position between the carriage 40 and the circuit board and the material of the flexible main body.

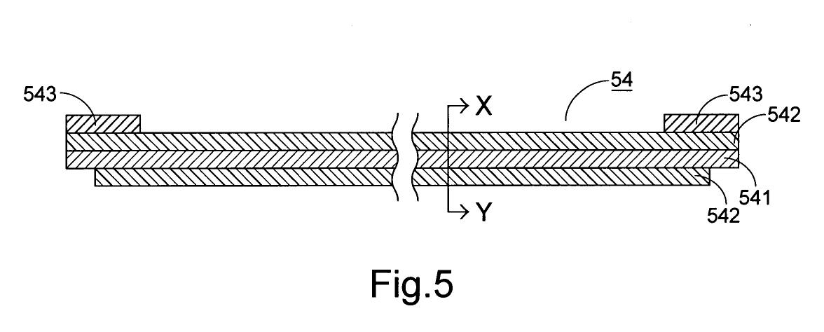

Please further refer to FIG. 5 illustrating an anti-abrasive flat flexible cable according to another preferred embodiment of the present invention. The anti-abrasive flat flexible cable 54 includes a flexible copper foil 541, a flexible thermoplastic insulating wrapper 542 and two rigid reinforcing insulating plates 543. The flexible thermoplastic insulating wrapper 542 encloses the flexible copper foil 541 with two ends of the copper foil 541 exposed to be electrically connected to the circuit board (not shown) and the carriage 40, respectively. The two rigid reinforcing insulating plates 543 are used to assist the user to easily plug the exposed copper foil 541 of the flat flexible cable 54 into the slots of the circuit board and the carriage 40.

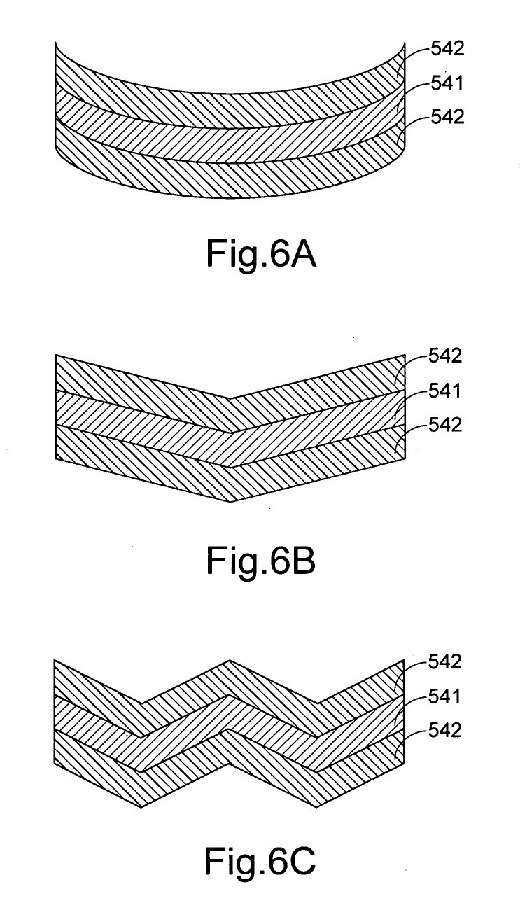

The distinguishing feature of this embodiment is that increased strength of the flat flexible cable 54 against free bending action. In order to achieve this purpose, the flat flexible cable 54 is formed with arc, V-shaped or W-shaped cross-section that is taken along the X-Y line of FIG. 5, and shown in FIG. 6A, 6B or 6C. It is understood that the curved or wrinkled flat flexible cable 54, forms a relatively rigid structure so that the bent portion thereof will not deform arbitrarily. Therefore, the flat flexible cable 54 and the transparent platform can be maintained isolated with proper clearance to avoid abrasion. The configuration of the cross-section is not strictly restricted, and varies with many factors such as material of the flat flexible cable. For example, for the one having an arc cross-section, the radius of the arc can be about 5˜30 mm. In the V-shaped cross-section, the angle between the two wings can be arranged from 30 to 170 degrees.

To sum up, the present invention effectively avoids the friction between the flat flexible cable and the transparent platform by setting the weighting object or modifying the configuration of the flat flexible cable to keep the flat flexible cable down away from the transparent platform. Therefore, the life span of the flat flexible cable and the imaging quality of the scanner can be improved.

While the invention has been described in terms of what is presently considered to be the most practical and preferred embodiments, it is to be understood that the invention needs not be limited to the disclosed embodiment. On the contrary, it is intended to shield various modifications and similar arrangements included within the spirit and scope of the appended claims which are to be accorded with the broadest interpretation so as to encompass all such modifications and similar structures.

What is claimed is:

1. An anti-abrasive flat flexible cable applied to a flatbed scanner connected between a circuit board and a carriage of said flatbed scanner and bending differentially with the forward or backward movement of said carriage under a platform of said flatbed scanner, said anti-abrasive flat flexible cable comprising:
a flexible main body connected to said circuit board and said carriage respectively, and transmitting electric signals between said circuit board and said carriage; and
a weighting object arranged on a portion of said flexible main body, which is possibly to be bent during said movement of said carriage, for pulling said flexible main body away from said platform so as to avoid abrasion.

2. The anti-abrasive flat flexible cable according to claim 1 wherein said flexible main body comprises:
a flexible conductor having one end connected to said circuit board and the other end connected to said carriage, respectively, for transmitting said electric signals; and
a flexible insulating wrapper enclosing said flexible conductor to protect said flexible conductor.

3. The anti-abrasive flat flexible cable according to claim 2 wherein said flexible conductor is a copper foil.

4. The anti-abrasive flat flexible cable according to claim 2 wherein said flexible insulating wrapper is made of thermoplastic material.

5. The anti-abrasive flat flexible cable according to claim 1 wherein said weighting object comprises a plurality of metal bars arranged in parallel.

6. The anti-abrasive flat flexible cable according to claim 5 wherein said plurality of metal bars are perpendicular to the movement direction of said carriage.

7. The anti-abrasive flat flexible cable according to claim 1 wherein said weighting object comprises a plurality of granular balls.

8. The anti-abrasive flat flexible cable according to claim 1 wherein said weighting object is arranged on an inner surface of said bent portion of said flexible main body during said movement of said carriage.

9. The anti-abrasive flat flexible cable according to claim 1 wherein said weighting object is distributed on said flexible main body between said carriage and a halfway portion of said flexible main body.

10. The anti-abrasive flat flexible cable according to claim 1 wherein the weight ratio of said weighting object to said flexible main body is greater than 10.

11. An anti-abrasive flat flexible cable applied-to a flatbed scanner connected between a circuit board and a carriage of said flatbed scanner and bending differentially with the forward or backward movement of said carriage under a platform of said flatbed scanner, said anti-abrasive flat flexible cable comprising:
a flexible conductor connected to said circuit board and said carriage respectively, and transmitting electric signals between said circuit board and said carriage; and
a flexible insulating wrapper enclosing and protecting said flexible conductor,
wherein said anti-abrasive flat flexible cable has a curved or wrinkled cross-section to resist against the free bending of said anti-abrasive flat flexible cable.

12. The anti-abrasive flat flexible cable according to claim 11 wherein said cross-section of said anti-abrasive flat flexible cable is arc-shaped.

13. The anti-abrasive flat flexible cable according to claim 11 wherein said cross-section of said anti-abrasive flat flexible cable is V-shaped.

14. The anti-abrasive flat flexible cable according to claim 11 wherein said cross-section of said anti-abrasive flexible cable is W-shaped.

15. The anti-abrasive flat flexible cable according to claim 11 wherein said flexible conductor is a copper foil.

16. The anti-abrasive flat flexible cable according to claim 11 wherein said flexible insulating wrapper is made of thermoplastic material.
